(19) United States
(12) Patent Application Publication
(10) Pub. No.: US 2007/0273918 A1
(43) Pub. Date: Nov. 29, 2007

(54) Printing Digital Documents

(76) Inventor: Manuel Gonzalez, Malaga (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/571,074

(22) PCT Filed: Aug. 27, 2004
(86) PCT No.: PCT/EP04/51939

§ 371 Date: Feb. 6, 2007

(30) Foreign Application Priority Data
Sep. 10, 2003 (GB) 0321166.1

(51) Int. Cl. G06F 3/12

(52) U.S. Cl. 358/1.15

(57) ABSTRACT

A method of printing a digital document comprises providing a first document for printing, the first document comprising at least one functional area in which pattern markings are to be printed, generating from the first document a second document in which at least one of the shape and or size and or location of the at least one functional area is modified, obtaining a portion of pattern to fit the modified functional area; and printing the second document. The modification may be performed at print time after the first document has been designed and published within a digital document processing system. An apparatus for processing a digital document is also provided.

### FIELD OF THE INVENTION

This invention relates to printing digital documents, and to digital pen and paper systems—sometimes called pen computing—in which documents are produced which include position identification pattern made up of markings printed on the document which can be detected by a suitable detection system and used to distinguish different positions on the documents.

### BACKGROUND OF THE INVENTION

It is known to use documents having such position identification markings in combination with a digital pen having an imaging system, such as an infra red camera, within it, which is arranged to image a small area of the page close to the pen nib. The digital pen includes a processor having image processing capabilities and a memory and is triggered by a force sensor in the nib to record images from the camera as the pen is moved across the document. From these images and information about the pattern the pen can determine the position of any marks made on the document by the pen. The markings can be stored either directly as graphic images, or perhaps as a sequence of “strokes/position on the document/time”, which can be passed from the pen to a suitable processor such as a personal computer.

The combination of the pen and the patterned paper allows, for example, forms with checkboxes on to be provided and the markings of the check boxes with the pen detected. In further applications the pen markings recorded by the pen may be analysed to recognise handwriting characters.

For such a system to be able to handle a large number of documents it is desirable for the system to be able to print a different pattern on every document. In this way, the pen cannot only tell where it is on a document but also what document it is. The size of the pattern, its so-called area in pattern space, should be made very large and the allocation of portions of the pattern to documents recorded. By publishing the document on a central server after it has been designed and recording the identity of a portion of pattern allocated to each published document on a database held on a server, which can be cross-reference with the pen readings, a very flexible and powerful system can be achieved.

An example of a system which employs this type of digital paper is known from Anoto AB, and information about the requirements for a suitable pattern can be found on their website at www.anoto.com.

At present, production of documents including pattern starts with the creation of a first document which contains some content using a document design tool. A portion of pattern is allocated to an area of the document and the document is published by storing the identity of the document on a central server along with the identity of one or more portions of pattern that are allocated to the document by a pattern allocation unit. A dedicated processing application or paper handling application is also created which is stored on a local server and provides information about how to handle markings made in the patterned areas. The location and identity of this application is also stored on the central server. Whenever a pen reads pattern from the paper, it contacts the central server which sends back the location of the paper application and the identity of the document. The pen information is then sent to the correct paper handling application for processing.

### SUMMARY OF THE INVENTION

According to a first aspect the invention provides a method of printing a digital document comprising:

providing a first document for printing, the first document comprising at least one functional area in which pattern markings are to be printed,

generating from the first document a second document in which at least one of the shape and or size and or location of the at least one functional area is modified,

obtaining a portion of pattern to fit the modified functional area, and

printing the second document.

An advantage of the present invention is that changes can be made to the first document at the time of printing which change the functional area whilst retaining the functionality of the pattern areas. For example, if the modification comprises scaling of the document to increase its size a standard method of printing would scale the whole document including the pattern in the pattern areas. This would change the spacing of the pattern markings which may render it unfunctional.

In the present invention the pattern is allocated after the document has been scaled and so the pattern marking spacing is not affected. Instead, the amount of pattern requested is chosen to match the modified size of the pattern areas.

The step of modifying the document and/or obtaining the pattern for the functional area may be performed by a print application such as a printer driver. This modification therefore occurs at print time, after the design and optional publication of the document in a digital paper processing system has occurred.

The printer driver may present to a user one or more prompts for the user to modify the original document. The prompts may be provided within the environment of a graphical user interface of a host PC or server or other processing device.

The method step of obtaining the pattern for the functional area may include a step of requesting a portion of pattern for the functional area from a pattern allocation device. This allocation device may be provided on a server connected to the host device which runs a print application and the method may therefore comprise requesting pattern from the host server.

The amount of pattern requested, and the identity of the pattern (its location in pattern space) may be determined according to the size of the modified functional area. For example, where the document is modified to scale up the content including the functional area, the method will comprise requesting a larger area of pattern for the functional area than would be requested if it was scaled down. In an alternative, the method may not scale the pattern but may instead request a larger portion of pattern to fill the area. The spacing between markings is important to the functionality and scaling the pattern could prevent it working.

The step of requesting pattern may comprise requesting an area of pattern larger than that which is required for a functional area of a document and allocating a sub-portion to the functional area according to how it has been modified. This is advantageous as a given area of pattern space can be allocated to a particular document regardless of how it is to be subsequently modified. The trade-off is that this ultimately means that more pattern needs to be allocated to a particular original document if each document is to have unique pattern printed thereupon.

The method step of modifying the functional area may comprise increasing its size, varying its aspect ratio or rotating the area relative to the remainder of the document.

It will be understood that the step of modification at the time of printing enables documents to be altered after they have been designed and published as part of a digital document processing system. The step of providing the first document may therefore comprise passing a document out from a document design application or retrieving a pre-designed document from a store.

According to a second aspect the invention provides a digital document processing apparatus comprising:

a print application which receives a first document for printing, the first document comprising at least one functional area in which pattern markings are to be printed,

a document generating means arranged to generate from the first document a second document in which at least one of the shape and or size and or location of the at least one functional area is modified, and

a pattern allocation unit which is arranged to allocate a portion of pattern to fit the modified functional area at the request of the print application in which the print application allocates pattern to the functional area according to its shape and or location and or size after modification

The print application may comprise a printer driver and it may generate a print file which comprises a set of instructions in a language which can be understood by a printing device. This may comprise a file written in a printer language such as Postscript or PCL.

The apparatus may include a printer which is adapted to print the modified document together with the pattern markings.

The pattern allocation unit may allocate a portion of pattern that is larger than that required and the print application may in turn allocate a sub-portion of this portion to the functional space. Where more than one functional space is present, a unique—yet again oversize—portion of pattern may be allocated to each functional area. This is advantageous as it keeps the step of allocating pattern to the modified areas local to the print application simple. Every time a request is made for pattern the pattern allocation unit can allocate a standard sized portion of pattern which the printer driver subdivides as needed. It may therefore simplify the communication from print application to pattern allocator. It is envisaged that the oversized portion of pattern may already have been allocated to the document whenever it is published on the server.

The pattern allocation unit or a separate unit may store a set of identifiers which uniquely identifies each of a set of first documents and may allocate a unique portion of pattern to each document. The print application may identify the first document that is being modified to the pattern allocator as part of the request for pattern. If the identifier is unknown to the pattern allocator it may add it to the set and allocate a new portion of unused pattern to the newly added document. The identifier may be created as a published document whenever a first document has been designed.

The apparatus may include a digital pen which is adapted to read pattern from a document printed by the apparatus, and a document processing means which is adapted to interpret the pen strokes from the digital pen according to a set of stored information about the pattern printed with the document.

The apparatus may provide details of the pattern printed in the at least one functional area to the document processing means. This ensures that the pen markings read by the pen can be matched up to the document in which they are printed. The print application may provide this information to the document processing means.

In one arrangement the document processing means may comprise a tailored paper application (computer program) running on a processor of a PC or the like which is adapted to interpret pen strokes for a document.

According to a third aspect the invention provides a computer program which is arranged to:

receive a first document for printing, the first document comprising at least one functional area in which pattern markings are to be printed,

generate from the first document a second document in which at least one of the shape and or size and or location of the at least one functional area is modified, and

request a portion of pattern to fit the modified functional area from a source of pattern, the program allocating pattern to the functional area according to its shape and or location and or size after modification.

The computer program may comprise a printer driver.

### BRIEF DESCRIPTION OF THE DRAWINGS

There will now be described, by way of example only, several embodiments of the present invention with reference to the accompanying drawings of which:

FIG. 1 shows a document printed according to an embodiment of the invention;

FIG. 2 shows in detail part of the document of FIG. 1;

FIG. 3 shows a computer system arranged to process information from the form of FIG. 1;

FIG. 4 shows a prior art pen suitable for use with the document of FIG. 1;

FIG. 5 shows an example of an embodiment of apparatus for creating the document of FIG. 1 in accordance with an aspect of the present invention;

FIG. 6 is a flowchart of the steps followed in the creation of a suitable document for printing along with a digital record of the document according to another aspect of the present invention;

FIG. 7 illustrates a print apparatus suitable for printing the document; and

FIG. 8 illustrates the flow of data when printing a modified document.

### DETAILED DESCRIPTION OF THE PREFERRED EMBODIMENTS

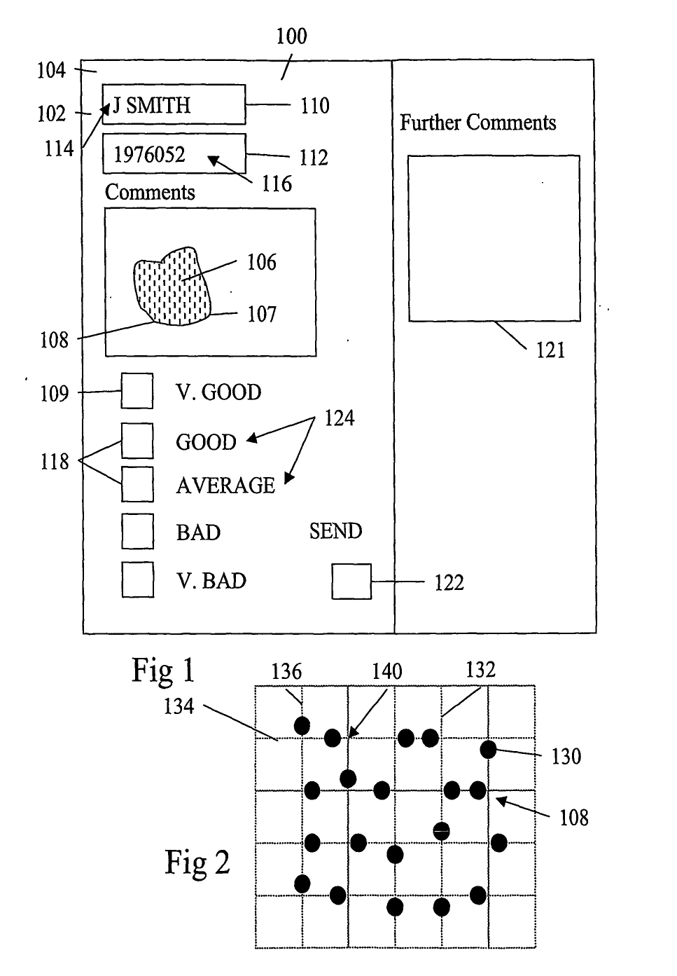

Referring to FIG. 1 a digital document 100 for use in digital pen and paper system comprises a carrier 102 in the form of a single sheet of A4 paper 104 (although it could be a carrier of any other material such as a plastics carrier material) with position identifying markings printed on some parts of it to form areas 107 of a position-identifying pattern 108. This background markings are referred to as “pattern” in this text. Also printed on the paper 104 are further markings 109 which are clearly visible to a human user of the form, and which make up the content of the form.

The content 109 will obviously depend entirely on the intended use of the document. In this case an example of a very simple two-page questionnaire is shown, and the content includes a number of boxes 110, 112 which can be pre-printed with specific information such as the users name 114 and a document identification number 116.

It is envisaged that the position-identifying pattern that is printed may have many forms but one suitable example is that shown in FIG. 2. The position-identifying pattern printed on the document is made up of a number of dots 130 arranged on an imaginary grid 132. The grid 132 can be considered as being made up of horizontal and vertical lines 134, 136 defining a number of intersections 140 where they cross. One dot 130 is provided at each intersection 140, but slightly offset in one of four possible directions up, down, left or right, form the actual intersection. The dot offsets are arranged to vary in a systematic way so that any group of a sufficient number of dots 130, for example any group of 36 dots arranged in six by six square, will be unique within the pattern space. An example of this type of pattern is described in WO 01/26033. It will be appreciated that other position identifying patterns can equally be used. Some examples of other suitable patterns are described in WO 00/73983 and WO 01/71643.

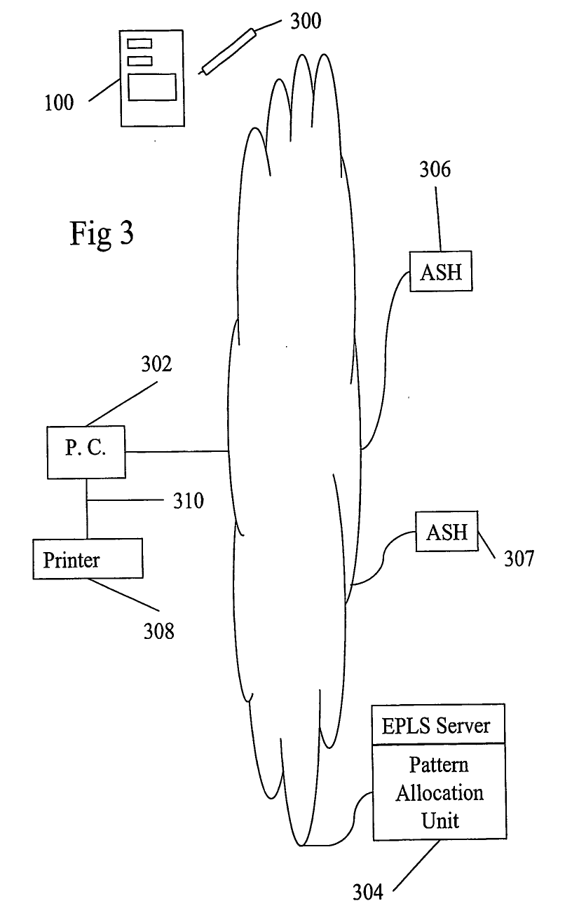

Referring to FIG. 3 a digital pen and paper system which includes the document 100 comprises a pen 300 arranged to write on the document 100 and to detect its position on the document from the pattern 108, and an internet connected personal computer (PC) 302 arranged to run an application for processing data from the pen 300, for example by modifying a file in which the document 100 is stored electronically in response to pen strokes made on the document 100 with the pen 300. The PC 302 includes a user interface including a screen 314, a keyboard 316 and a mouse 318, as well as a processor, a memory, and I/O software devices by means of which the processor communicates with the screen 314, the keyboard 316, the mouse 318 and a communications port by means of which it communicates with the internet. The system also includes a central internet connected server 304 which has stored on it information corresponding to the published document 100 such as its identity.

An application service handler (ASH) 306, which is a program run, in this case, on a separate server having its own memory, processor I/O devices and communications port, is also provided with Internet connection. The ASH 306 is arranged to interpret the pen strokes recorded by the pen 300, as described below, converting them to an input suitable for the application on the PC 302. The ASH may include an intelligent character recognition (ICR) program so that it can interpret handwritten input on the document 100 and convert it to digital text. A further ASH 307 is also provided, and is associated with a different application and arranged to interpret pen strokes for that application. In this example, there is one ASH for each application that makes use of the digital pen and paper system.

Each ASH 306, 307 needs to have access to information about the layout of any particular document 100 including the positions, dimensions and functions of each of the patterned areas so that it can process any pen strokes made on the document 100. This information can be obtained from the central server 304 which has installed on it an application known as an enterprise paper look-up service (EPLS) as explained below.

The enterprise paper lookup service (EPLS) 304 is provided on the central server with Internet connection to the host PC which supports the pen. A proxy service running on the host PC connects to the EPLS whenever pen strokes arc received. The EPLS includes a program arranged to receive data from the pen when the pen has been used on the document 100, the data identifying which areas of pattern space have been written on. Typically the pattern space that is associated with the send box 122, and which the pen 300 has recognized as a prompt to contact the EPLS, is identified to the EPLS application.

The information held on the central server 304 as part of the EPLS application includes a database of published documents (information about the documents layout and size etc), pen identities and, importantly a database of pattern portions allocated to particular published documents. The central server 304 also includes a pattern allocation unit which allocates pattern to the published documents and which the EPLS can interrogate to determine the unique identity of the document 100 by relating the pattern that is read by the pen with the published documents in the database, and which application the document is associated with, and therefore which of the ASHs 306, 307 should be used for that application. The EPLS identifies the appropriate ASH 306 and the document identity to the pen. The pen can then send the pen stroke data and the document identity to the correct ASH 306, 307.

It will be understood that the various components of the system can all be located at separate locations, communicating via the internet as described. Alternatively some or all of them could be provided together on a single server, or grouped on a local network. This might be appropriate where a self-contained system for a limited number of applications is required.

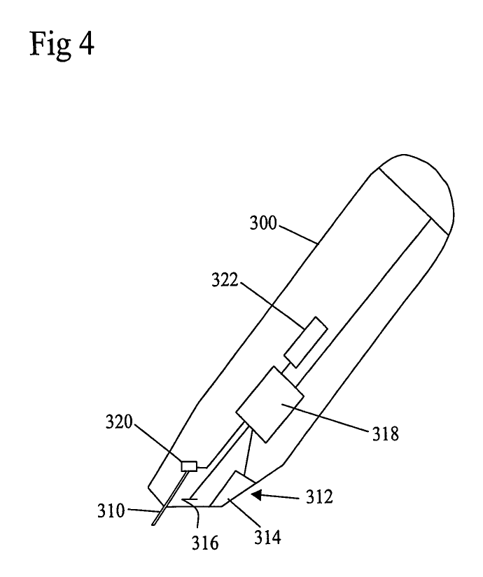

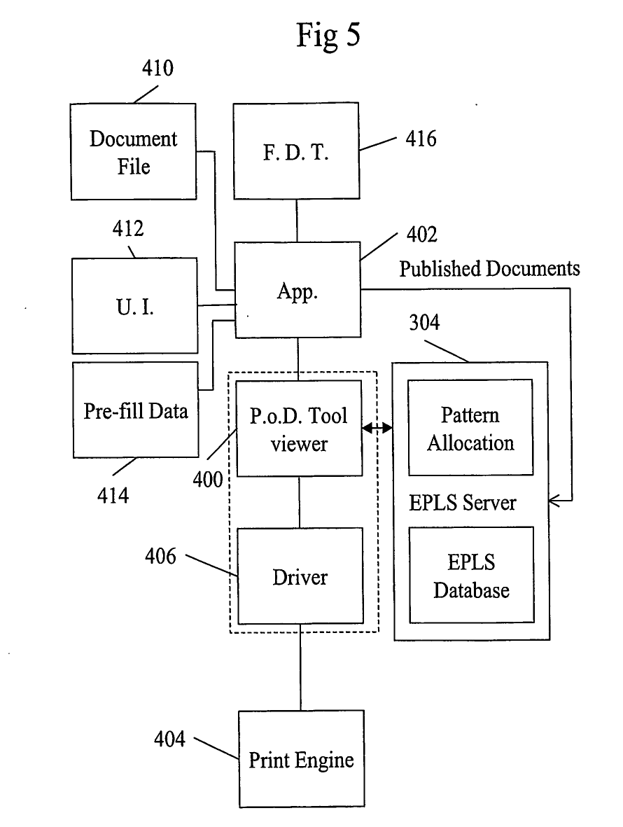

Referring to FIG. 4, the pen 300 comprises a writing nib 310, and a camera 312 made up of an infra red (IR) LED 314 and an IR sensor 316. The camera 312 is arranged to image a circular area adjacent to the tip 311 of the pen nib 310. A processor 318 processes images from the camera 312. A pressure sensor 320 detects when the nib 310 is in contact with the document 100 and triggers operation of the camera 312. Whenever the pen is being used on a patterned area of the document 100, the processor 318 can therefore determine from the pattern 108 the position of the nib of the pen whenever it is in contact with the document 100. From this it can determine the position and shape of any marks made on the patterned areas of the document 100. This information is stored in a memory 320 in the pen as it is being used.

When the user has finished marking the document, in this case when the questionnaire is completed, this is recorded in a document completion process, for example by making a mark with the pen in the send box 122. The pen is arranged to recognise the pattern in the send box 122 and determine from that pattern the identity of the document 100. It then sends this document identification information to the EPLS 304, which identifies the relevant ASH 306 to the pen 300, by sending the URL of the ASH 306 to the pen 300. The pen stroke data is then sent by the pen 300 to the ASH 306. The pen 300 can be connected to the network in any suitable manner, but in this case it is via a Bluetooth radio link with the PC 302. Suitable pens are available from Logitech under the trademark Logitech lo.

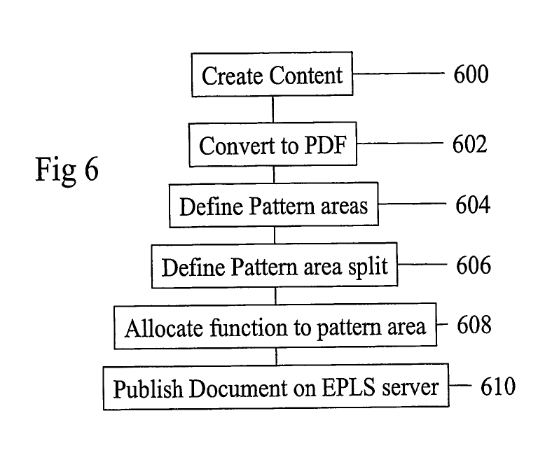

A set of digital documents 100 for use in the system of FIG. 3 can be produced in many ways. In a convenient method, the first step is the design and creation of the document content. Referring to FIG. 6 this starts at step 600 with the design of the content of the document, which is carried out on the PC using the application 402 or some other application. In this case the application is Acrobat Reader and the PC 302 also runs a number of other applications including a word processing package such as ‘Word’, a database package such as ‘Access’ and a spreadsheet package such as ‘Excel’. Each of these can be used to design the content of the document. In a typical use of the invention, data from a database is fitted to a number of fields in a template to produce a personalised document. Then the areas of the document to which the pattern 108 are to be applied are defined by the user. In a simple case pattern is only used to identify a digital document but in other cases two or more areas of pattern could be given different functions. In each case this is carried out using a form design tool (FDT) 416 in the form of an Acrobat 5.0 plug-in. The content is therefore converted to PDF format at step 602, and the pattern areas defined using the FDT 416 at step 604, producing a digital document defining both the content and the positions and shapes of the pattern areas.

The user may define functions associated with the various patterned areas defined at step 608 so that the application 402 can process data received back when the document 100 has been written on. In the case of the questionnaire document 100 the pattern areas in the larger boxes 120, 121 are identified as a graphical input areas, for which any pen markings should be stored graphically, or perhaps analysed using character recognition and stored as text. The pattern associated with the check boxes 118 is associated with the respective response options so that the checking of the boxes 118 on a number of the forms 100 produces a standard mark, such as a cross, in the check box of the stored document. The pattern associated with the send box 122 is associated with the send function which will cause the pen to stop recording pen strokes for the document 100 and send them to the ASH 306.

Once the document 100 has been named, the user indicates, using the FDT 416 that it is completed. The PDT then creates a Paper Application Definition (PAD) file—the information about the published document—which is a file defining those features or parameters of the document 100 that will be needed by the ASH 306 to interpret pen strokes made on the document 100. Those parameters may include the size and shape of the pattern areas, their relative positions in pattern space as indicated by a unique pattern ID or perhaps a seed for producing the portion of pattern, and their functions, such as whether they are check boxes, areas for graphical input, areas for ICR analysis or areas having other functions.

These parameters are the ones necessary to allow the processing of pen strokes made on the document 100 using the pen 300.

The document is named at step 610 and then “published” on the central server by sending at step 612 the PAD file to the EPLS 304 when the document 100 has been finished and printed and before it is written on with the pen, so that the EPLS can tell the ASH how to interpret pen strokes on the document 100 and produce the necessary inputs to the application 402. Keeping this PAD file on the EPLS means it is readily available to any ASH that wants access to it.

Of course, it is to be understood that the document could be designed in many other ways, and it may not be necessary to allocate pattern to the document at all at this initial stage, the pattern being allocated at the print stage. The document design may simply identify functional areas in which pattern is needed, perhaps by indicating their boundary and adding a marker or tag to say that “pattern is needed here”. These markers or tags can be saved along as part of the completed document together with the document content.

Having defined a document and published it at the EPLS, the user is ready to print the document. The printing of the digital document—comprising the content and a pattern which is allocated to it at the print stage—may be achieved in a single pass process using any printer that has a sufficient resolution to produce the dots of the pattern.

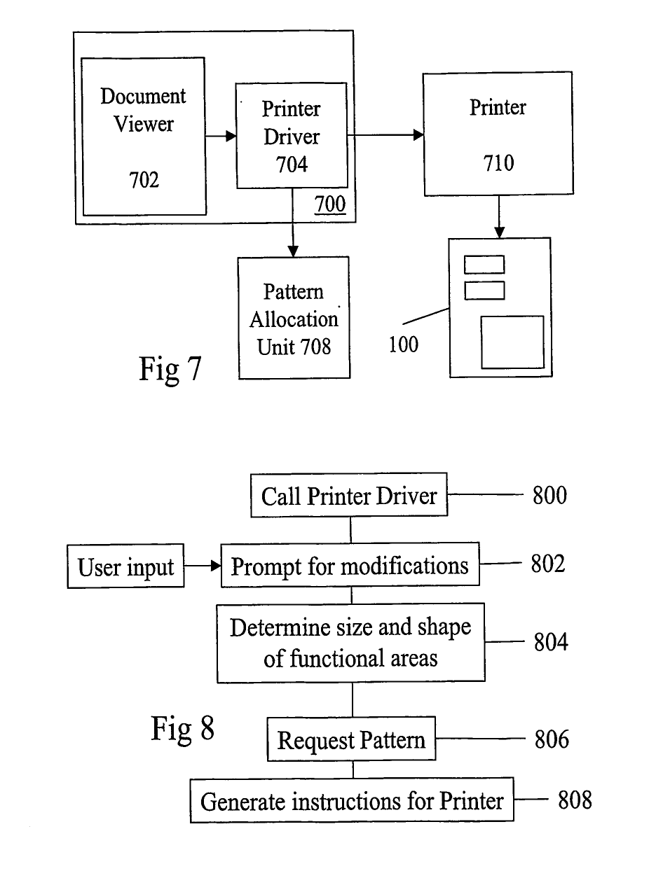

FIG. 7 shows an overview of the functional units of a digital document printing apparatus according to our embodiment, which comprises a computer 700 that the document is stored on prior to printing and a printer 710 which is connected to the computer. The computer provides a document viewing application 702 for viewing and/or editing the document to be printed (typically the same FDT used to create the form) and a printer driver application 704 which produces a set of print instructions. The printer 710 includes a print controller which receives the print instructions from the printer driver and in turn prints the document. A pattern allocation unit is also connected to the printer driver across a network connection. The printer driver has access to a pattern allocation unit 708. The printer and the computer arc basically standard apparatus known in the art but the computer is loaded with software which causes it to provide a method of printing in accordance with one embodiment of the present invention.

The workflow for printing a document using the apparatus of FIG. 7 is illustrated in FIG. 8 of the accompanying drawings. When a user decides to print a document, a print application—in this example a document viewer and associated printer driver is called up 800. The viewer 702 may comprise a readily available application such as Acrobat reader. In a typical graphical user interface, such as Microsoft Windows, running a word processing package to design a form, such as Word 6.0, calling the printer driver is performed by selecting “file” then click “print” in the drop down box that appears below. This will cause the printer driver at step 802 to display a set of visual prompts on the screen to which the user can respond. These prompts may include the option to print the document with or without pattern and other modifications.

The other modifications prompted by the printer driver may include scaling of the document to fit to a range of document sizes (e.g. A3 or A5) or to a custom size. They may include altering the document's aspect ratio, perhaps scaling it to fit a page size in one or both of the horizontal and vertical directions. It may be a combination of these. It could, indeed, be any form of modification that could be offered by a standard prior art printer driver that affect size or shape of the pattern areas.

The prompts for modifications could be radio buttons or other graphical images displayed to the user on a screen, the user responding by positioning a marker over the radio button and pressing a key or button of a keyboard or mouse connected to the computer 700.

Once the modification of the document is complete the printer driver determines 804 the size and shape of the functional areas of the modified document and contacts the pattern allocation unit to request at step 806 an amount of pattern. The pattern allocated depends on the shape and size of the pattern areas after modification. The pattern is then allocated at step 808 to the modified area by the printer driver they have been modified. The printer driver converts the modified document with pattern into a set of print instructions that can be sent to the printer. The printer on receiving these print instructions can then print out a digital document with the required pattern in the functional areas. Finally, the allocated pattern is associated with the PAD file on the EPLS such that when a pen reads this pattern the EPLS directs the pen strokes to the correct ASH.

The pattern allocation unit may supply the printer driver with a portion of pattern that is larger than the document as originally designed. In this case, the printer driver may select sub-portions of pattern from within this to fit to the functional area. In this way, the request made to the pattern allocation unit is simplified as the printer driver always asks for the same amount of pattern regardless of the modifications made to the document. In an alternative, it could request specific portions for each functional area.

As indicated, once the modified document has been created and sent to print (by generating an appropriate set of print instructions) the details of the pattern allocated to the printed document are stored at the EPLS to be linked to or to form part of the PAD file to enable the ASH to take into account changes to the pattern used.

It will, of course, be understood that by functional area in this work we may simply mean an area which is printed with a pattern of positional markings. Such areas could be allocated a function such that an application performs a specific task when a pen indicates that markings have been made in one of these areas, but this is not essential to the invention. Indeed, the pattern of digital markings may simply provide the function of identifying which document has been marked by a pen and therefore provide a form of document watermark. In this case, the system may simply comprise a store in which pattern and corresponding published document details are held, a pattern allocation unit and an appropriate printer driver or other printing application.

1-15. (canceled)

16. A method of printing a digital document comprising:
providing a first document for printing, the first document comprising at least one functional area in which pattern markings are to be printed,
generating from the first document a second document in which at least one of the shape and or size and or location of the at least one functional area is modified,
obtaining a portion of pattern to fit the modified functional area; and
printing the second document.

17. The method of claim 16 in which the first document includes some content.

18. The method of claim 17 in which the step of modifying the document and/or obtaining the pattern for the functional area is performed by a print application such as a printer driver.

19. The method of claim 18 in which the printer driver presents to a user one or more prompts for the user to modify the first document.

20. The method of claim 16 in which the step of modifying the document and/or obtaining the pattern for the functional area is performed by a print application such as a printer driver.

21. The method of claim 16 in which the step of obtaining the pattern for the functional area includes a step of requesting a portion of pattern for the functional area from a pattern allocation device.

22. The method of claim 21 in which the amount of pattern requested and the identity of the pattern (its location in pattern space) is determined according to the size of the modified functional area.

23. The method of claim 22 in which the step of requesting pattern comprises requesting an area of pattern larger than that which is required for a functional area of a document and allocating a sub-portion to the functional area according to how it has been modified.

24. The method of claim 21 in which the step of requesting pattern comprises requesting an area of pattern larger than that which is required for a functional area of a document and allocating a sub-portion to the functional area according to how it has been modified.

25. The method of claim 16 in which the step of modifying the functional area comprises increasing its size, varying its aspect ratio or rotating the area relative to the remainder of the document.

26. A digital document printing apparatus comprising:
a print application which receives a first document for printing, the first document comprising at least one functional area in which pattern markings are to be printed,
a document generating means arranged to generate from the first document a second document in which at least one of the shape and or size and or location of the at least one functional area is modified, and
a pattern allocation unit which is arranged to allocate a portion of pattern to fit the modified functional area at the request of the print application in which the print application allocates pattern to the functional area according to its shape and or location and or size after modification.

27. The apparatus of claim 26 in which the print application is arranged to generate a print file which comprises a set of instructions in a language which can be understood by a printing device.

28. The apparatus of claim 27 which includes a printer which is adapted to print the second document together with the pattern markings.

29. The apparatus of claim 26 in which the pattern allocation unit allocates a portion of pattern that is larger than the required and the print application allocates a sub-portion of this portion to the functional space.

30. The apparatus of claim 27 in which the pattern allocation unit allocates a portion of pattern that is larger than the required and the print application allocates a sub-portion of this portion to the functional space.

31. The apparatus of claim 26 in which the pattern allocation unit stores a set of identifiers which uniquely identifies each of a set of first documents and allocates a unique portion of pattern to each document.

32. The apparatus of claim 27 in which the pattern allocation unit stores a set of identifiers which uniquely identifies each of a set of first documents and allocates a unique portion of pattern to each document.

33. The apparatus of claim 28 in which the pattern allocation unit stores a set of identifiers which uniquely identifies each of a set of first documents and allocates a unique portion of pattern to each document.

34. The apparatus of claim 29 in which the pattern allocation unit stores a set of identifiers which uniquely identifies each of a set of first documents and allocates a unique portion of pattern to each document.

35. A computer program which is arranged to:
receive a first document for printing, the first document comprising at least one functional area in which pattern markings are to be printed,
generate from the first document a second document in which at least one of the shape and or size and or location of the at least one functional area is modified, and
request a portion of pattern to fit the modified functional area from a source of pattern, the program allocating pattern to the functional area according to its shape and or location and or size after modification.
